(19) United States
(12) Patent Application Publication
(10) Pub. No.: US 2022/0176723 A1
(43) Pub. Date: Jun. 9, 2022

(54) APPARATUS FOR CONTINUOUS SUBLIMATION THERMAL PRINTING AND/OR REACTIVATION

(71) Applicant: MONTI ANTONIO S.P.A., Thiene (IT)

(72) Inventor: Vincenzo MONTI, Thiene (IT)

(21) Appl. No.: 17/538,023

(22) Filed: Nov. 30, 2021

(30) Foreign Application Priority Data
Dec. 3, 2020 (IT) 102020000029660

(51) Int. Cl. B41M 5/382

(52) U.S. Cl. CPC B41M 5/38221

(57) ABSTRACT

An apparatus for continuous sublimation thermal printing and/or reactivation, which includes a calendering unit and a

vacuum chamber which is adapted to contain the calendering unit in the phase of operation. The vacuum chamber has a body closed by a door at an open and flanged end of the body and a substantially horizontal axis of extension.

### CROSS-REFERENCE TO RELATED APPLICATIONS

This application is related to and claims the benefit of Italian Patent Application No. 102020000029660, filed on Dec. 3, 2020, the contents of which are herein incorporated by reference in their entirety.

### TECHNICAL FIELD

The present disclosure relates to an apparatus for continuous sublimation thermal printing and/or reactivation.

### BACKGROUND

Sublimation thermal printing is a method, now widespread in the textile sector, for example in the printing of rugs, casual knitwear, furniture fabrics, advertising banners, carpets, other garments and clothing accessories.

In sublimation thermal printing, a paper on which a print pattern (a design, writing or a logo) is impressed is placed in contact with the surface of the material to be printed, bringing them into contact with each other, and the whole is heated to a temperature such that the ink of the pattern undergoes the sublimation effect, whereby its vapors partially penetrate the surface of the material to be printed, in so doing becoming fixed to it and so producing the desired print.

In the sector of sublimation thermal printing, there are substantially two techniques:
flat thermal printing, executed on sheets of preset dimensions by pressing the sheet with the print pattern on the surface to be printed between two plates, one of which is heated, using a press,
continuous thermal printing, executed using an adapted calendering unit, wherein a spool of print pattern and a spool of material to be printed are unreeled, bringing them into contact and pressing them against each other at a heated roller which activates the ink sublimation process.

In continuous sublimation thermal printing, the paper with the print pattern winds continuously around the heated roller and the material to be printed faces toward it.

In particular, a tubular felt is arranged around the heated roller and is partially wound around it, and is adapted to follow and push the material toward the roller, thus pushing it on the paper with the print pattern.

By contrast, in continuous sublimation reactivation a material is passed through a calendering unit, similar to the unit used for sublimation thermal printing, but the material has previously been printed with sublimating inks using a fabric printer, and therefore with no transfer from a paper with the print pattern.

These sublimating inks, already present on the material, are reactivated during the contact with the heated roller, resulting in their sublimation.

In substance, the sublimating ink printed on the material is fixed in the fibers of that material via contact with the heated roller of the calendering unit, which causes its sublimation.

Such conventional techniques have some drawbacks, however.

Such methods, in fact, enable a uniform distribution of colors on the surface of the material to be printed, for example the surface of an item of clothing, a furnishing etc., but not a satisfactory penetration of the inks into the fibers of the garment itself.

Substantially, the color is fixed only in the superficial part of the garment; therefore, if the weft of the fabric is splayed, especially if it is elastic, fibers can be seen which have no color.

### SUMMARY

The present disclosure provides an apparatus for continuous sublimation thermal printing and/or reactivation which is capable of improving the known art in one or more of the abovementioned aspects.

The disclosure provides an apparatus for continuous sublimation thermal printing and/or reactivation that enables a stronger penetration of the ink into the fibers than conventional apparatuses for continuous sublimation thermal printing and/or reactivation.

The disclosure provides an apparatus for continuous sublimation thermal printing and/or reactivation that enables more rapid processing and more production, for the same length of time and penetration of the ink into the fibers, than flat sublimation thermal printing.

Furthermore, the present disclosure sets out to overcome the drawbacks of the background art in a manner that is alternative to any existing solutions.

The disclosure further provides an apparatus for continuous sublimation thermal printing and/or reactivation that is highly reliable, easy to implement and low-cost.

This aim and these and other advantages which will become more apparent hereinafter are achieved by providing an apparatus for continuous sublimation thermal printing and/or reactivation, comprising a calendering unit, characterized in that it comprises a vacuum chamber which is adapted to contain said calendering unit in the phase of operation.

### BRIEF DESCRIPTION OF THE DRAWINGS

Further characteristics and advantages of the disclosure will become more apparent from the detailed description that follows of a preferred, but not exclusive, embodiment of the apparatus for continuous sublimation thermal printing and/or reactivation, according to the disclosure, which is illustrated for the purposes of non-limiting example in the accompanying drawings wherein:

FIG. 1 is a view of a first configuration of an apparatus for continuous sublimation thermal printing and/or reactivation, according to the disclosure;

FIG. 2 is a view of a second configuration of an apparatus for continuous sublimation thermal printing and/or reactivation, according to the disclosure;

FIG. 3 is a first cross-sectional view of the configuration of FIG. 2;

FIG. 4 is a second cross-sectional view of the configuration of FIG. 2, taken along the line IV-IV, of FIG. 3;

FIG. 5 is a view of a first detail of the apparatus of FIG. 1; and

FIG. 6 is a view of a second detail of the apparatus of FIG. 1.

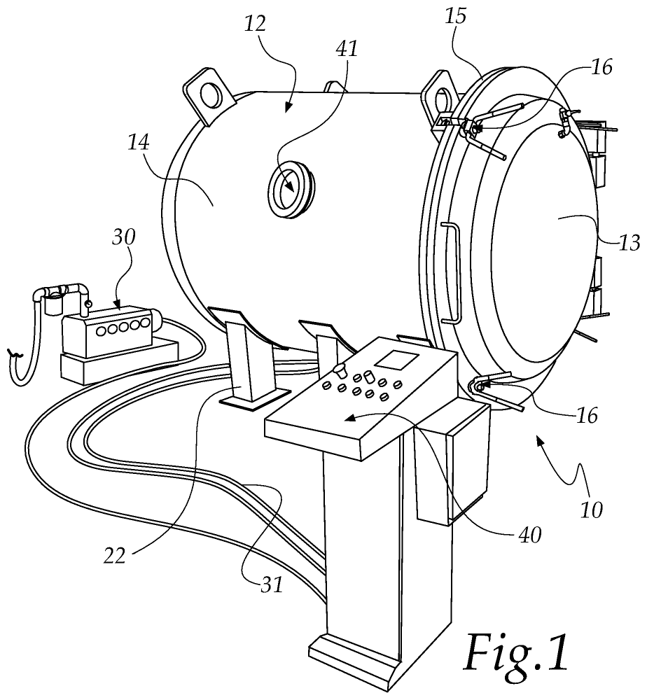

### DETAILED DESCRIPTION OF THE DRAWINGS

With reference to the figures, an apparatus for continuous sublimation thermal printing and/or reactivation, according to the disclosure, is generally designated by the reference numeral 10.

The apparatus 10 comprises a calendering unit 11, of a type known per se.

One of the particularities of the disclosure consists in the fact that the apparatus 10 comprises a vacuum chamber 12 which is adapted to contain the calendering unit 11 in the phase of operation.

In particular, the chamber 12 has a substantially cylindrical extension with a body 14 which is closed by a door 13, at an open and flanged end 15 of the body 14.

In other variations of embodiment, not shown in the figures, the chamber 12 has a different extension.

At the end 15 there is a sealing gasket, not shown in the figures, against which the door 13 abuts when the chamber 12 is closed.

The body 14 is supported by a plurality of supporting feet 22.

The chamber 12 has a substantially horizontal axis of extension.

The door 13 is fixed to the end 15 of the body 14 by way of a hinge 17, and is closed hermetically against it, in the phase of operation of the apparatus 10, by way of a plurality of butterfly clamps 16 which are arranged along the perimetric rim of the end 15.

In the embodiment shown in the figures, opening and closing the chamber 12 occurs manually; however, in other variations of embodiment, not shown in the figures, the apparatus 10 comprises automatic means of opening and closing the chamber 12.

The apparatus 10 comprises a vacuum pump 30 which is fluidically connected to the chamber 12, and is adapted to create an adjustable level of vacuum inside the chamber 12 comprised between −0.1 atm and −1 atm of negative pressure.

Such apparatus 10 comprises a vacuum gauge, not indicated in the figures, in order to show the level of vacuum reached inside the chamber 12.

The apparatus 10 comprises a control panel 40 which is external to the chamber 12 and is connected both to the vacuum pump 30 and to the calendering unit 11.

This control panel 40 is adapted to control both the calendering unit 11 and the vacuum pump 30.

In particular, the control panel 40 is connected to the calendering unit 11 via cables 31 and pneumatic and/or hydraulic conduits 33 which pass through at least one wall of the body 14 of the chamber 12 in respective glands 32 and connectors 34, all hermetically sealed and all capable of maintaining the level of vacuum created inside the chamber 12 in the phase of operation of the apparatus 10.

The calendering unit 11 can slide between the inside and the outside of the chamber 12, when the latter is open, through the end 15 of the body 14, and has a plurality of wheels 20.

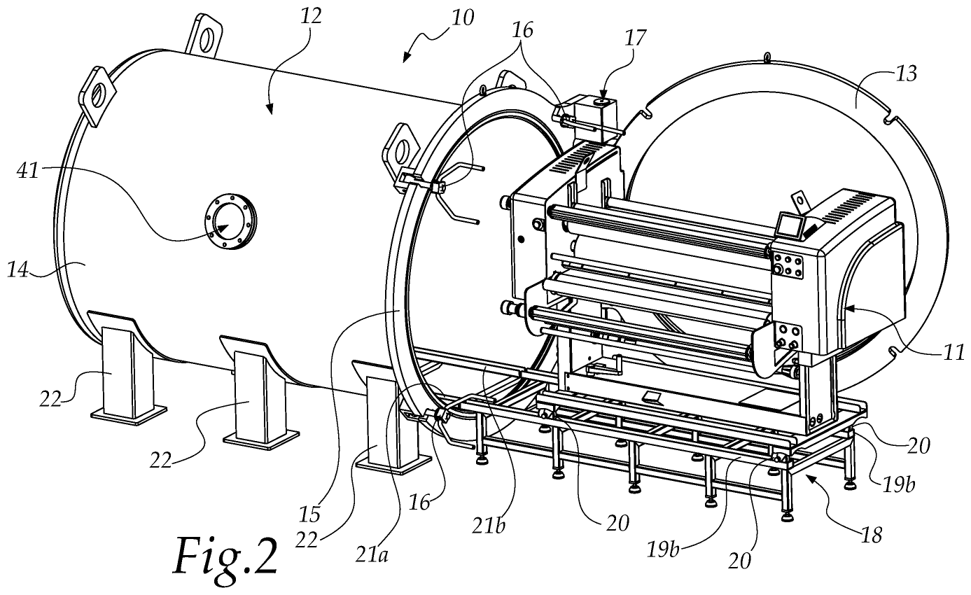

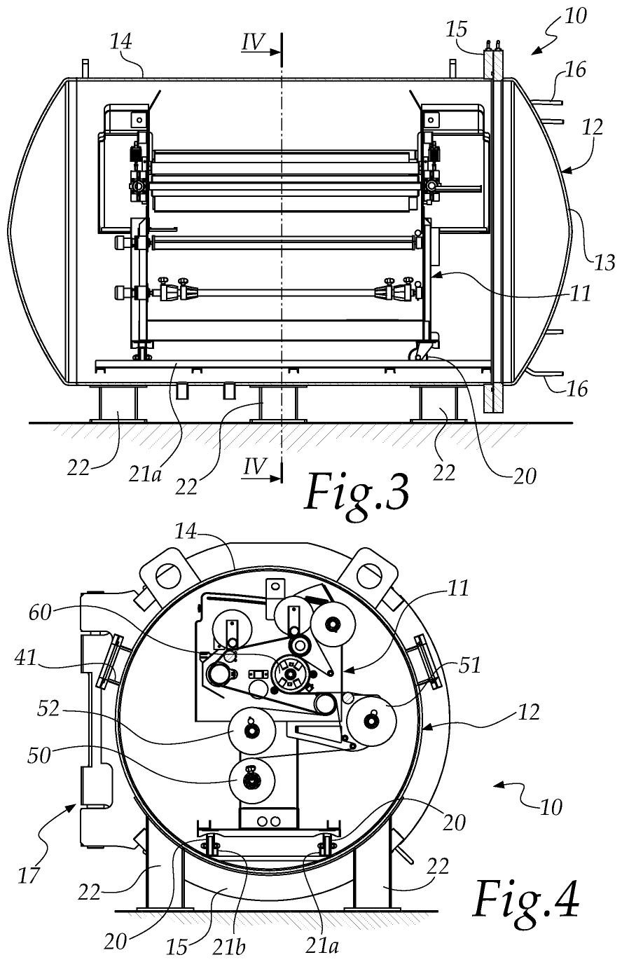

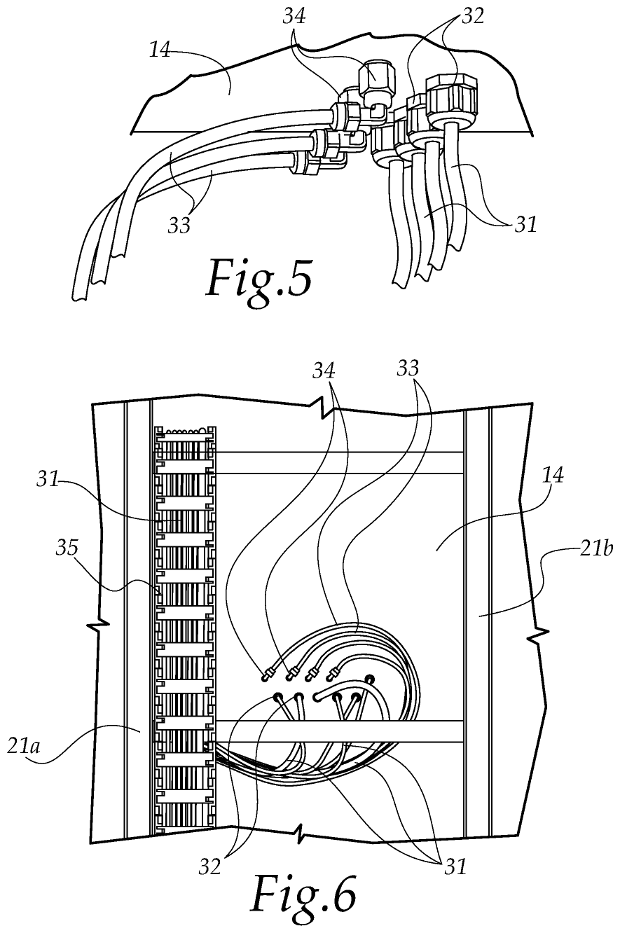

With reference to FIG. 2, the apparatus 10 comprises a base 18 for loading/unloading the calendering unit 11, which is removable and has two first guides 19a, 19b for sliding of the calendering unit 11, on which corresponding wheels 20 of the calendering unit 11 roll.

This base 18 for loading/unloading has an extension that is substantially comparable to the extension of the calendering unit 11 and has the same axis of extension as the chamber 12, starting from its open and flanged end 15.

The base 18 is positioned at the end 15 of the chamber 12 for the operations to load/unload the calendering unit 11.

Inside the chamber 12, there are two second guides 21a, 21b, each one corresponding to one of the first guides 19a, 19b, of the base 18, on which the wheels 20 of the calendering unit 11, mentioned above, can roll.

A flexible cable trough 35 extends from the calendering unit 11 in the direction of the inside of the chamber 12, the cables 31 and the conduits 33 running partially inside it, each from the respective gland 32 or connector 34, inside the chamber 12, to the calendering unit 11 itself.

The direction of extension of this trough 35 is parallel to the direction of extension of the second guides 21a, 21b, and reduces its extension in that direction, folding back on itself, as the calendering unit 11 moves inside the chamber 12.

In the example shown in the figures, the operations to load/unload the calendering unit 11 and consequent insertion/extraction thereof into/from the chamber 12 are carried out manually; however, in other variations of embodiment, not shown in the figures, the apparatus 10 comprises automatic means of:
loading/unloading the calendering unit 11,
inserting/extracting the calendering unit 11 into/from the chamber 12.

The body 14 has a porthole 41, adapted to allow visual contact with the inside of the chamber 12 during the phase of operation.

In a variation of embodiment, not shown in the figures, inside the body 14 of the chamber 12 there are one or more video cameras for viewing the interior.

Operation of the apparatus 10, according to the disclosure, is as follows.

The calendering unit 11 is positioned on the base 18 for loading/unloading, and the following are mounted on it:
a spool 50 of material to be printed,
a spool 51 of paper with the print pattern to be transferred onto the fabric,
a spool 52 of protective paper adapted to protect the felt that envelops the heated roller 60.

The various spools are then set up to begin the printing operations.

At this point the calendering unit 11 is inserted into the chamber 12 and the door 13 is closed, hermetically, using the sealing gasket mentioned previously.

Then the vacuum pump 30 is actuated, via the control panel 40, in order to provide a level of vacuum inside the chamber 12 with an adjustable negative pressure comprised between −0.1 atm and −1 atm.

Using the vacuum gauge, the level of vacuum inside the chamber 12 is measured.

Once the desired negative pressure is reached, the calendering unit 11 is actuated and the sublimation thermal printing and/or reactivation is executed, under vacuum conditions.

The calendering unit 11 can also be actuated before the entry into the chamber 12, for example by setting the lowest processing speed, in order to reduce waste of materials.

To execute a sublimation reactivation only, the method is similar to the one described above, except that a spool of material is loaded on the calendering unit 11 that has previously been printed with sublimating ink, for example using a fabric printer, and it is not necessary to load the spool of paper with the print pattern.

From experimental tests, it has emerged that continuous sublimation thermal printing and/or reactivation using a calendering unit 11, under conditions of negative pressure, inside the chamber 12, enables a better penetration of the ink into the fibers than with conventional apparatuses for continuous sublimation thermal printing and/or reactivation.

Furthermore, using a calendering unit inside a vacuum chamber it is possible to carry out continuous printing operations on spools of materials of considerably larger dimensions and in less time, with respect to what can be obtained with the flat sublimation thermal printing technique, and for the same penetration of the ink into the fibers.

In practice it has been found that the disclosure fully achieves the intended aim and objects by providing an apparatus for continuous sublimation thermal printing and/or reactivation that enables a better penetration of the ink into the fibers than conventional apparatuses for continuous sublimation thermal printing and/or reactivation.

With the disclosure an apparatus for continuous sublimation thermal printing and/or reactivation has been devised that enables more rapid processing and more production, for the same length of time and penetration of the ink into the fibers, than flat sublimation thermal printing.

The disclosure thus conceived is susceptible of numerous modifications and variations, all of which are within the scope of the appended claims. Moreover, all the details may be substituted by other, technically equivalent elements.

In practice the materials employed, provided they are compatible with the specific use, and the contingent dimensions and shapes, may be any according to requirements and to the state of the art.

1. An apparatus for continuous sublimation thermal printing and/or reactivation, the apparatus comprising: a calendering unit, and a vacuum chamber which is adapted to contain said calendering unit in the phase of operation.

2. The apparatus according to claim 1, wherein said vacuum chamber has a body which is closed by a door, at an open and flanged end of said body.

3. The apparatus according to claim 1, wherein said vacuum chamber has a substantially horizontal axis of extension.

4. The apparatus according to claim 2, wherein said door is fixed to said open and flanged end of said body with a hinge, said door being closed hermetically against said body, in the phase of operation of said apparatus, with a plurality of butterfly clamps arranged along a perimetric rim of said open and flanged end.

5. The apparatus according to claim 4, further comprising a vacuum pump which is fluidically connected to said vacuum chamber.

6. The apparatus according to claim 1, further comprising a vacuum gauge.

7. The apparatus according to claim 5, further comprising a control panel which is external to said vacuum chamber and is connected both to said vacuum pump and to said calendering unit.

8. The apparatus according to claim 7, wherein said control panel is connected to said calendering unit via cables and pneumatic and/or hydraulic conduits which pass through at least one wall of said body of said vacuum chamber in respective hermetically-sealed glands and connectors.

9. The apparatus according to claim 4, wherein said calendering unit has a plurality of wheels and is configured to slide between an inside and an outside of said vacuum chamber, when said vacuum chamber is open, through said open and flanged end of said body.

10. The apparatus according to claim 8, further comprising a base for loading/unloading said calendering unit, said base is removable and has two first guides for sliding of said calendering unit on which corresponding wheels of said calendering unit are configured to roll, said base having a same axis of extension as said vacuum chamber starting from said open and flanged end of said body.

11. The apparatus according to claim 10, wherein inside said vacuum chamber there are two second guides, each one of said second guides corresponds to one of said first guides on which said wheels of said calendering unit are configured to roll.

12. The apparatus according to claim 11, wherein a flexible cable trough extends from said calendering unit in a direction of an inside of said vacuum chamber, said cables and said conduits running partially inside it, each from the respective one of said glands or connectors, inside said chamber, to said calendering unit, said trough having a direction of extension that is parallel to the direction of extension of said second guides.

13. The apparatus according to claim 2, wherein said body has a porthole.
